(19) United States
(12) Patent Application Publication
(10) Pub. No.: US 2010/0039346 A1
(43) Pub. Date: Feb. 18, 2010

(54) Asymmetric Radome For Phased Antenna Arrays

(75) Inventors: Michael J. Peter, Huntington Station, NY (US); Peter M. Corcoran, Kings Park, NY (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 12/106,469

(22) Filed: Apr. 21, 2008

(51) Int. Cl. H01Q 1/42

(52) U.S. Cl. 343/872; 342/368

(57) ABSTRACT

An antenna assembly comprises a plurality of antenna elements arranged in an array, and a radome for protecting the antenna elements, wherein the radome has a thickness that changes across a field of view to normalize insertion phase delay differences in an incoming signal passing through the radome and received by the antenna elements.

### STATEMENT OF GOVERNMENT INTEREST

This invention was made under Contract No. N00019-04-C-0005. The United States Government has rights in this invention under the contract.

### FIELD OF THE INVENTION

This invention relates to antenna assemblies and, more particularly, to radomes for use with radar systems using active and/or passive antenna arrays.

### BACKGROUND OF THE INVENTION

Radome design and configuration are important elements affecting the overall performance of high frequency radar applications where signal phase and transmission uniformity is required for optimum system performance. Specifically, the signal quality and therefore performance of airborne radar systems that use active and passive phased arrays can be marginalized by the aerodynamic contouring of radomes of conventional design used to protect the antennas from the environment. Antenna system applications of interest include active and passive phased arrays that employ a plurality of antenna elements arranged in a planar array and are used to perform scanning functions in transmission and receiving. Such systems are used for direction finding (DF), scanning synthetic aperture radar (SAR) and related applications. External influences such as the contour of the radome can alter the signal phase and power in a non-uniform manner such that phase and power differences are introduced to the wave between the measurement antenna pairs that are not consistent with the unperturbed wave. Errors in resolution and direction are produced when unaccounted ray phase and power differences are processed. These radome induced phenomenon can be large, resulting in computation errors that cause a loss of DF accuracy and SAR resolution.

A “look-up” table can be used by the signal processor to correct some phase anomalies, but the degree of correction is usually limited to compensation for small manufacturing variations in the radome, internal system tolerances and/or external electromagnetic interferences caused by other systems, and is usually impractical for the degree of difference of insertion phase delay (IPD) and transmitted power induced by highly contoured radomes.

Radomes are commonly used to protect antenna arrays from environmental conditions and can consist of a solid half wave design or thin wall construction, A-sandwich, B-sandwich, or C-sandwich designs. In each design type, the constituent materials are of a constant thickness and, in the case of the sandwich designs, the facesheets have a constant parallel offset provided by the core material. When an incoming signal arrives at the radome at a given angle of incidence (AOI), only some of the radio frequency (RF) energy is transmitted through the radome. Some of the RF energy is reflected and some is absorbed by the radome materials in proportion to the material's dielectric properties and thickness, known as transmission loss. The wave also experiences some refraction as it passes through the different radome constituents, which affect the wave's phase velocity, and consequently the signal phase, known as insertion phase delay (IPD). The state-of-the-art for radome design is highly developed to address these issues. There are many methods that can be employed to define materials and thickness for the radome constituents to optimize/tune the radome design to minimize transmission losses and changes in phase over a desired frequency range.

Ideally, radomes should be electrically transparent to the incoming RF signal for any wave polarization and angle of incidence (AOI) relative to the radome surface. In reality most conventional radome designs will adversely influence the characteristics of the incoming wave front to some degree. To address these influences and minimize errors between array antenna elements, radomes are manufactured using strict quality control to make the radome RF properties the same as viewed by each antenna element in the array for a given angle of arrival (AOA) across the antenna field of view. The radome is also mounted in such a way as to minimize signal variations with respect to the antenna/array. As an example, for direction finding (DF) antenna applications based on phase interferometry (PI), radome uniformity is especially critical to maximize signal source location accuracy and requires the radome be mounted parallel to the plane of the antenna. In phase interferometry the phase difference of the received signal planar wave front is measured between pairs of antenna elements separated by different inter-element spacings. The signal phase difference as received by the antenna element pairs is proportional to the sine of the angle of arrival of a received signal. Based on this phase difference and knowledge of frequency, the signal is processed and the direction to the source of the incoming signal is computed. Errors in this calculation diminish the accuracy in determining the direction to the signal source. This criteria also applies to the design of synthetic aperture radar (SAR) radomes where transmission power and signal phase information is used to generate accurate imaging.

If the radome is chosen to be an A-sandwich design, which consists of two uniform constant thickness facesheets and a uniform constant thickness core, and is configured to be flat and parallel to the planar array face, then, for any given angle of incidence (AOI), each of the individual antenna elements receives a signal that has had the same radome induced insertion phase delay (IPD). A nearly error free system is created as the net phase difference and transmitted power are unaltered, and the data can be processed to determine the direction of the reflected signal as for phase interferometry direction finding (PIDF) applications or, object resolution as for synthetic aperture radar (SAR) applications within the accuracy of the individual system.

However, operational requirements for contour conformity and structural integrity can result in a radome design that adversely influences the signal wave front as it reaches different parts of the antenna array. For many airborne applications, there is a need to operate the antenna array within a streamlined radome. To meet aerodynamic requirements, the radome shape must be highly contoured. When a conventional A-sandwich is highly contoured, there is a significant variation of the radome curvature, which causes variations in RF signal wave characteristics. The incoming signal wave front AOI varies and takes different path lengths through the radome as viewed by the individual antenna elements in the array over their field of view, which results in different IPD's or delta IPD.

As the planar wave front impinges across a highly contoured radome from any angle, each portion of the wave front creates a different AOI with the radome surface normal and experiences different amounts of RF transmission, reflection and absorption depending on where the wave front meets the radome surface. Therefore, for a constant thickness radome, each portion of the wave front experiences a different amount of absorption and IPD due to the different path length taken through the corresponding contour presented by the radome.

For DF arrays: If each individual antenna element in a measurement pair receives a signal, which has passed through the radome at a different angle of incidence and a different apparent radome thickness, then the time and phase delays for the incoming signal caused by the radome will be different, thereby introducing different IPD between measurement antenna element pairs. This delta IPD can be significant and, as a result can be great enough to severely diminish the DF accuracy of the system. A similar scenario exists for all active and passive arrays.

There is a need for a streamlined radome structure that reduces variations of an incoming signal for various angles of incidence over a desired field of view.

### SUMMARY OF THE INVENTION

This invention provides an antenna assembly comprising a plurality of antenna elements arranged in an array, and a radome, wherein the radome has a thickness that changes across a field of view to normalize insertion phase delay differences in an incoming signal passing through the radome and received by the antenna elements.

### BRIEF DESCRIPTION OF THE DRAWINGS

FIG. 1 is a cross-sectional view of a conventional antenna assembly having a flat A-sandwich radome.

FIG. 2 is a cross-sectional view of a conventional antenna assembly having a streamlined A-sandwich radome of conventional design.

FIG. 3 is a cross-sectional view of an antenna assembly having a streamlined A-sandwich radome constructed in accordance with this invention.

### DETAILED DESCRIPTION OF THE INVENTION

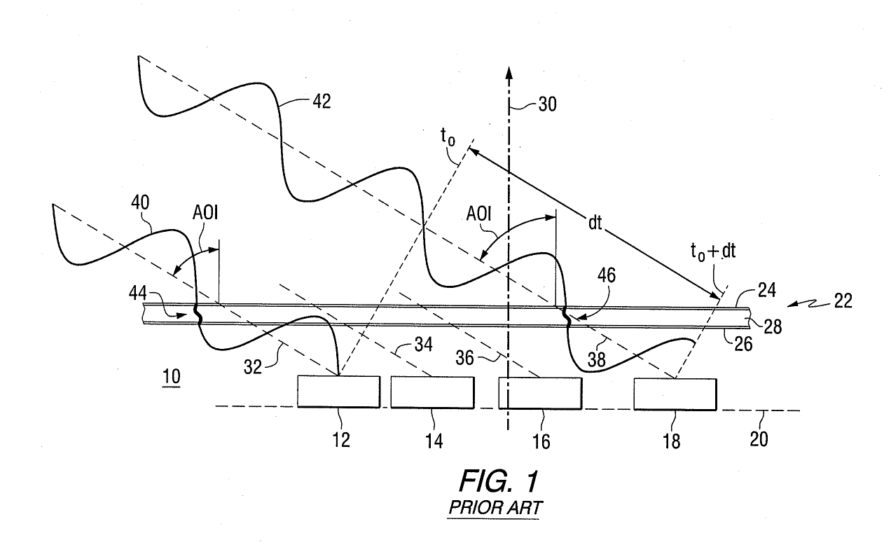

Referring to the drawings, FIG. 1 is a cross-sectional view of an antenna array assembly 10 including a plurality of antenna elements 12, 14, 16 and 18 mounted on a common plane 20 and having a flat A-sandwich radome 22. The radome includes an outer layer, or skin, 24 and an inner layer, or skin, 26 positioned on opposite sides of a core layer 28. The skins and core each have a uniform thickness. In common designs, the thin skins are a relatively dense material, such as plastic or laminated fiber reinforced plastic, and the core layer is a thicker low density material, having for example a foam or honeycomb structure.

Arrow 30 represents the array bore sight direction. In this example, individual rays of a single incoming signal, represented by lines 32, 34, 36 and 38, impinge on the radome at a uniform angle of incidence (AOI). The incoming signal is assumed to have a planar wave front and as such has equal phase at all points on the wave front. Consider, for example, portions of the incoming signal represented by waves 40 and 42. Wave 40 passes through the radome in a region 44 and is subjected to insertion phase delay (IPD) and transmission loss. Similarly, wave 42 passes through the radome in a region 46 and is subjected to insertion phase delay (IPD) and transmission loss. At time tₒ, wave 40 reaches antenna element 12. At time tₒ+dt, wave 42 reaches antenna element 18. Because the radome is a planar structure, wave 40 and wave 42 will be subject to similar insertion phase delay (IPD) and transmission loss. Thus the portions of the incoming signal that pass to the antenna elements will all be subjected to the same radome effects which results in no relative ray phase changes upon reaching the respective antenna elements.

The angle of incidence is measured with respect to the normal (perpendicular) direction at the surface of the radome and at the point where the incoming signal reaches the radome. Conventional signal processing devices, not shown, would be used to determine the phase differences between the signal portions received by the antenna elements and to determine the direction of the source of the incoming signal. The incoming signal can be, for example, an echo from a target or a signal transmitted by a signal source.

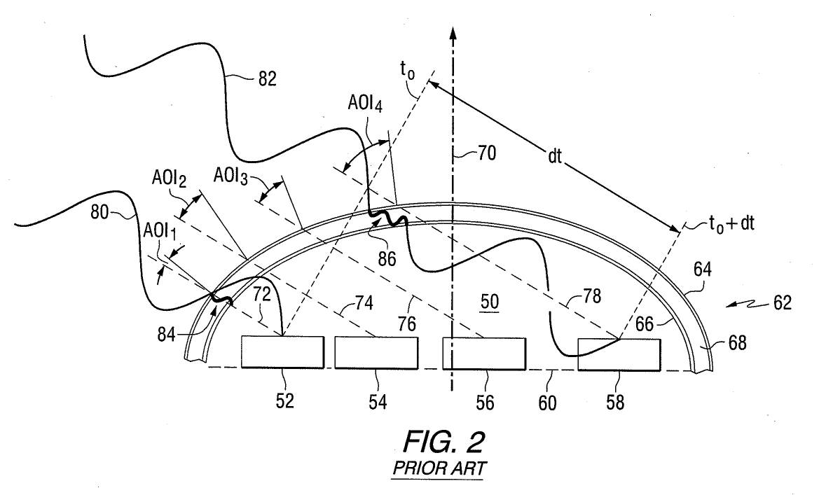

FIG. 2 is a cross-sectional view of a conventional antenna array assembly 50 including a plurality of antenna elements 52, 54, 56 and 58 mounted on a common plane 60 and having a streamlined A-sandwich radome 62. The radome includes an outer layer, or skin, 64 and an inner layer, or skin, 66 positioned on opposite sides of a core layer 68. The skins and core each have a uniform thickness. Arrow 70 represents the antenna bore sight direction. In this example, an incoming ray represented by lines 72, 74, 76 and 78 impinges on the radome at different angles of incidence, AOI₁, AOI₂, AOI₃ and AOI₄, due to the curvature of the radome. Consider, for example, portions of the incoming rays represented by waves 80 and 82. Wave 80 passes through the radome in a region 84 and is subjected to insertion phase delay (IPD) and transmission loss. Similarly, wave 82 passes through the radome in a region 86 and is subjected to insertion phase delay (IPD) and transmission loss. At time to, wave 80 reaches antenna element 52. At time tₒ+dt, wave 82 reaches antenna element 58. Because the radome is a streamlined structure, wave 80 and wave 84 will be subject to different insertion phase delay (IPD) and transmission loss. Thus the portions of the incoming rays that pass to the antenna elements will be subjected to different radome effects resulting in a delta IPD. This introduces error in the phase difference calculations required to determine the direction of the incoming signal source.

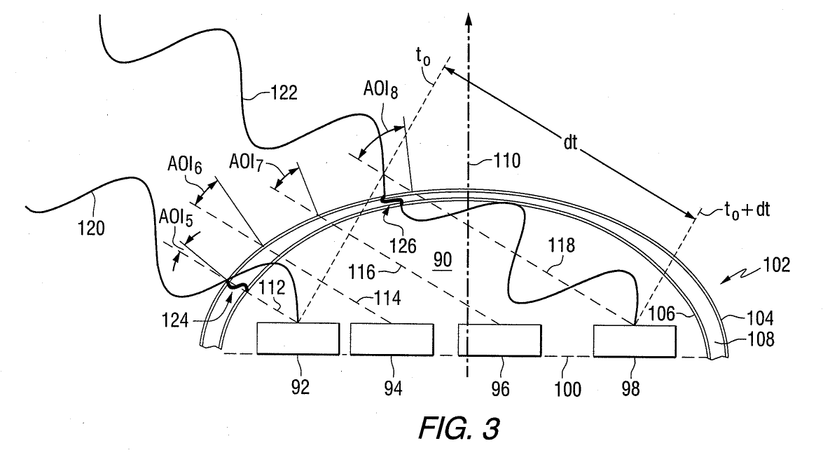

FIG. 3 is a cross-sectional view of an antenna array assembly 90 constructed in accordance with this invention and including a plurality of antenna elements 92, 94, 96 and 98 mounted on a common plane 100 and having a streamlined A-sandwich radome 102.

The radome includes an outer layer, or skin, 104 and an inner layer, or skin, 106 positioned on opposite sides of a core layer 108. The thickness of the radome varies across the field of view of the antenna and can be measured throughout the manufacturing process via techniques such as ultrasonic inspection, or by using a coordinate measurement machine (CMM).

Arrow 110 represents the antenna bore sight direction. In this example, portions of an incoming signal represented by lines 112, 114, 116 and 118 impinge on the radome at different angles of incidence, AOI₅, AOI₆, AOI₇ and AOI₈. Due to the varying thickness of the radome core layer, the portions of the incoming signal that pass to the antenna elements will all be subjected to the same radome effects. These effects include, for example, a time delay and phase shift in the incoming signal as it passes through the radome.

Consider, for example, portions of the incoming signal represented by waves 120 and 122. Wave 120 passes through the radome in a region 124 and is subjected to insertion phase delay (IPD) and transmission loss. Similarly, wave 122 passes through the radome in a region 126 and is subjected to insertion phase delay (IPD) and transmission loss. At time tₒ, wave 120 reaches antenna element 92. At time tₒ+dt, wave 122 reaches antenna element 98. The thickness of the radome changes across the field of view of the antenna. By providing a streamlined radome of varying thickness, wave 120 and wave 122 will be subject to similar insertion phase delay (IPD) and transmission loss. Thus the portions of the incoming signal that pass to the antenna elements will all be subjected to the same radome effects.

The radome thickness can be controlled by varying the thickness of any or all of the skins and the core. The core thickness can be varied to accommodate phase tuning over a frequency range and the skin thickness variation can also be used to control transmission loss.

In the example of FIG. 3 the thickness variation of the radome normalizes IPD for each antenna element. As used in the description, a normalized IPD is an IPD resulting from a path through the varying core thickness that is approximately equal to other IPD's throughout the radome.

Radomes constructed in accordance with this invention have constituent material thicknesses that vary asymmetrically in a prescribed manner across the field of view. The embodiment of FIG. 3 is based on an A-sandwich design but varies the core thickness and/or the skin thickness. However, the invention is not limited to A-sandwich designs. Other radome constructions, such as a single layer, B-sandwich, C-sandwich, multilayer, etc., can also be used. The radome can be constructed of any materials used in state-of-the-art radomes. The thickness changes and material selection are defined and carefully controlled to optimally tune the RF performance of the streamlined radome to normalize the IPD differences and transmission between measurement antenna elements for any given angle of arrival (AOA).

By normalizing the IPD and transmission between measurement antenna elements, the delta phase delays and transmission loss differences due to the radome curvature are minimized, thereby reducing subsequent system errors. In one embodiment, the array of antenna elements can be compromised of circularly polarized spiral antennas acting as a phase interferometer. In this case the entire radome is designed to optimize the IPD difference between any paired antenna elements and is also tuned to minimize the overall transmission losses. The thickness can be defined by using a combination of RF finite element analysis software and iteration algorithms.

The radomes of this invention utilize a unique radome wall design, which varies the thickness of one or more of the constituent dielectric layers across the field of the radome window for the purpose of impedance matching and phase normalization. Impedance matching and phase normalization are achieved through the systematic and continuous variation of the thickness of the dielectric material layers that constitute the radome walls. This invention can be applied to the radome and phased array to optimize the RF performance of the antenna array where phase and transmission uniformity are critical.

The radome compensates for reflections of the incoming signal using constituent materials that have their thickness continuously varied to maximize RF performance. The thickness of the core is used to “tune” the radome. The facesheet thickness predominantly determines transmission loss. As a ray passes through the constituent layers of the radome, reflections occur at each transition/layer interface. The reflections can be phased to cancel each other through selection of the relative dielectric properties between the materials, the layer thickness, and the shape. For example, at a given frequency/wavelength the core thickness can be set to approximately ¼ wavelength to eliminate internal signal cancellation. For broadband applications, a narrow band (i.e., the midband) can be chosen to set the core thickness. This is further complicated by the variation of core thickness required by this invention to compensate for the radome contour. A “best” compromise in performance must be reached with the end user to bound the design.

While an A-sandwich radome has been described to illustrate the operation of the invention, it should be understood that the invention can be applied to any radome design, including half wave solid structures and other sandwich designs. The variation of the dielectric material thickness is unrestricted and can accommodate many different radome shapes. In one embodiment, this invention provides an asymmetric radome design for insertion phase error correction and transmission loss reduction for antennas used in streamlined radome applications. A continuously variable radome wall thickness is used to compensate for a highly contoured radome to normalize ray path IPD differences.

This invention provides IPD control for any phased array antenna assembly having a radome that counteracts and minimizes the insertion phase delay differences produced by a radome, while holding transmission losses to a prescribed minimum. While the invention can be used to mitigate the phase differences induced by the radome contour for a phase interferometer antenna application, it may also be used in other applications to control ray paths through any type of radome. Transmission losses can be mitigated through careful design and material selection. The thickness variation is intended to accommodate a wide angular field of view of incoming signals. This invention is not intended to reduce losses, but only to normalize and maintain them at acceptable levels.

The invention equalizes physical path lengths and will function over all RF frequencies and polarizations. IPD is directly proportional to the frequency, but delta IPD is not frequency dependent. Delta IPD is the IPD difference between rays and is responsible for computation errors. It is most effective for higher frequencies where, for the degree of surface contour, the delta IPD caused by the variable path length is a significant percentage of the accuracy of the array. For example, at 300 MHz, a highly contoured radome would cause delta IPD's on the order of 0.1 deg. The same radome at 20 GHz would cause delta IPD>10 deg. Performance enhancements will be most compromised at the extremes of AOI and contour.

While FIGS. 1, 2 and 3 show a linear array of antenna elements, the invention also encompasses other arrays of antenna elements, such as two-dimensional arrays or combinations of arrays. A single row of antenna elements will return only Azimuth or Elevation DF; two orthogonally mounted arrays are required to obtain both.

Any type of antenna elements can be used, for example, spiral elements positioned on axes that extend normal to the antenna plane. Alternatively, the antenna elements can be, for example, crossed dipoles, loops or waveguides.

The radome can be constructed of any materials suitable for the given application. Common materials are AstroQuartz™ (AQ)/Cyanate-Ester (CE) fiber reinforced plastic (FRP) for the skin or facesheets and Nomex™ honeycomb for the core. Material selection is based on application frequency range and aircraft induced requirements such as, flight loads due to aerodynamic pressure, rain and hail impact and, operating temperature. There are well-established radome materials and design practices that can be used in the design of the radome. This invention can take advantage of these materials as well as any newly developed materials or material combinations.

While the invention has been described in terms of several embodiments, it will be apparent to those skilled in the art that various changes can be made to the described embodiments without departing from the scope of the invention as set forth in the following claims.

What is claimed is:

1. An antenna assembly comprising:
a plurality of antenna elements arranged in an array; and
a radome, wherein the radome has a thickness that changes across a field of view to normalize insertion phase delay differences in an incoming signal passing through the radome and received by the antenna elements.

2. The radar of claim 1, wherein the radome has a solid half wave or thin wall construction.

3. The radar of claim 2, wherein the thin wall construction comprises one of:
an A-sandwich, a B-sandwich, or a C-sandwich structure.

4. The radar of claim 3, wherein the A-sandwich structure includes a core layer positioned between two skin layers, the B-sandwich includes a skin layer positioned between two core layers, and the C-sandwich includes two core layers positioned between three skin layers.

5. The radar of claim 2, wherein the solid half wave construction is a single layer.

6. The radar of claim 1, wherein the array is a linear array.

7. The radar of claim 1, wherein the array is a planar array.

8. The radar of claim 1, wherein the antenna elements are spiral elements, loops, crossed dipoles or waveguides.

9. The radar of claim 1, wherein the insertion phase of the incoming signal is controlled by the radome.
